(19) United States
(12) Patent Application Publication
(10) Pub. No.: US 2004/0229540 A1
(43) Pub. Date: Nov. 18, 2004

(54) Dustproof clothing

(75) Inventors: Eiji Akiba, Akashi-shi (JP); Teruo Hori, Takatsuki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KURARAY CO. LTD., Kurashiki-shi (JP)

(21) Appl. No.: 10/833,094

(22) Filed: Apr. 28, 2004

(30) Foreign Application Priority Data
May 15, 2003 (JP) 2003-137700

(51) Int. Cl. B32B 3/00; D03D 15/00; D04H 1/00; D04H 3/00; B32B 9/00; D03D 25/00; B32B 5/02; D04H 5/00; D04H 13/00

(52) U.S. Cl. 442/327; 442/333; 442/332; 442/361; 442/362; 442/363; 442/364; 442/354

(57) ABSTRACT

A dustproof clothing comprises a fabric, and at least part of the fabric comprises a dustproof fiber containing a photocatalyst and a dust-collecting agent. The dust-collecting agent may comprise a quadrivalent metal phosphate and a bivalent metal hydroxide. The photocatalyst may comprise an optical semiconductor (e.g., an oxide semiconductor such as titanium dioxide). In the dustproof fiber, the proportion of the photocatalyst may be about 0.1 to 25 parts by weight relative to 100 parts by weight of the dustproof fiber, and the proportion of the dust-collecting agent may be about 1 to 25 parts by weight relative to 100 parts by weight of the dustproof fiber. Since the dust collection efficiency of the fabric in the dustproof clothing is not less than 70% and the air permeability of the fabric is about 8 to 100 cm/second, the dustproof clothing is suited to a clothing for a clean room. Thus, the present invention provides a dustproof clothing having both a high dust collection efficiency and an air permeability concurrently.

### FIELD OF THE INVENTION

The present invention relates to a dustproof clothing usable as a working clothing (or work suit) in a clean room, which has not only an excellent dust collection efficiency but also a high air permeability, and ensures comfortableness to wear.

### BACKGROUND OF THE INVENTION

In various electronics fields including a semiconductor field, a clean room is generally employed for manufacturing electronics devices (e.g., a semiconductor). In such a clean room, a demand for high level cleanliness is recently increasing. In order to adapt to the demand, a dustproof working suit used in a clean room has also been improved variously along with the development of filters for air cleaning.

As dust (or a dust particle) caused by workers, the following three categories of dust are usually known, that is,

(1) clothing dust generated from a dustproof clothing itself,

(2) penetration dust penetrating the dustproof clothing, which originates from a worker's body itself and from underwears that the worker wears, and

(3) leaking dust leaking from cut-out portions of a clothing, which originates from a worker's body itself and from underwears that the worker wears.

Against the above-mentioned three categories of dust, the countermeasures have been taken one by one. First, as the countermeasure against the clothing dust (1), a synthetic continuous fiber having no free end (a so-called filament fiber) has come into common use. The level of the clothing dust is usually considerably reduced at present.

Moreover, as the countermeasure relative to the penetration dust (2), the developments of a fabric (or cloth) having a low air permeability have proceeded by densification of the fabric, or by coating the fabric with a sealing resin. Thus, by the above-mentioned method, inhibiting the penetration of dust is generally realized, and the penetration dust has become to a lower level.

Further, as the countermeasure for the leaking dust (3), some methods has been proposed, for example, a method for reducing cut-out portions of a clothing, a method for fastening the cut-out portions, and a method for attaching an electret sheet-like matter, having electric function, to the cut-out portions of the clothing. For example, Japanese Patent Application Laid-Open No. 33806/1987 (JP-62-33806A) discloses a dustproof clothing worn in a clean room, which aspirates air within the body of the clothing by a dust collecting device. Inside of the clothing, a plurality of induction tubes are disposed so that tips or ends of the each tube are located in various parts (such as collar, lower sleeve edge, and bottom), respectively, to form suction or induction paths from these tips or ends up to the dust collecting device. In the dustproof clothing, the leakage of contaminated air from the inside of the clothing is inhibited by inducing a pressure difference between inside and outside of the clothing. Moreover, Japanese Patent Application Laid-Open No. 101103/1994 (JP-6-101103A) discloses a dustproof clothing which comprises a stretch knitting and a non-stretch knitting and has a configuration such that a neck part and lower sleeve edges fit into a human body, wherein, at least one of the neck part and the lower sleeve edges employs a stretch knitting having an air permeability of 10 to 100 cm/second and a dust collection efficiency at 20% extension of not less than 70%, and being knitted with a specific polyester continuous fiber.

Various countermeasures have taken for such a penetration dust and a leaking dust, thereby a dustproof clothing achieving low level of dusting characteristics has been developed. However, the fact is that there is no dustproof clothing which satisfies comfortableness to wear. Because the dustproof clothing reducing the air permeability for enhancing the dust collection efficiency also inhibits a permeability of moisture from a human body, a worker who works with wearing the dustproof clothing is forced to work in the unpleasant warm environment and damp due to moisture trapped in the dustproof clothing. Moreover, the use of a special stretch knitting deteriorates the wearing comfortableness due to feeling of oppression.

As techniques to solve such problems, in order to improve the wearing comfortableness, the kind of a continuous fiber to be used and the standards for a fabric have been investigated in various ways such as enhancing an air permeability with maintaining an excellent dust collection efficiency. For example, Japanese Patent Application Laid-Open No. 321075/1993 (JP-5-321075A) proposes a dustproof woven textile in which either the warp or the weft is a polyester multifilament yarn having a shrinkage in boiling water of not more than 4%, and the other is a polyester yarn having different shrinkage filaments, wherein the total cover factor of the warp or weft is 2500 to 3500. However, it has been recently required that a dustproof clothing achieves a further improved dust collection efficiency, and an excellent air permeability to satisfy (comfort with) comfortableness, concurrently. At the moment, the fact is that there is no satisfactory dustproof clothing for these requirements.

On the other hand, Japanese Patent Application Laid-Open No. 284011/1996 (JP-8-284011A) discloses a deodorizing fiber containing a photocatalyst and an absorbent. In this document, an optical semiconductor (such as titanium oxide) is described as the photocatalyst, and a quadrivalent metal phosphate and a bivalent metal hydroxide are described as the absorbent.

### SUMMARY OF THE INVENTION

It is therefore an object of the present invention to provide a dustproof clothing which has both a high dust collection efficiency and a high air permeability concurrently.

It is another object of the present invention to provide a dustproof clothing which realizes comfortableness to wear with maintaining or having a high dust collection efficiency, and is suitable for using in a clean room.

The inventors of the present invention made intensive studies to achieve the above objects and finally found that a preparation of a dustproof clothing with a fabric which comprises a fiber containing a photocatalyst and a dust-collecting agent ensures a high dust collection efficiency without deteriorating an air permeability. The present invention was accomplished based on the above findings.

That is, the present invention includes a dustproof clothing (an article of dustproof clothing) which comprises a fabric, wherein at least part of the fabric comprises a dustproof fiber containing a photocatalyst and a dust-collecting agent. The dust-collecting agent preferably comprises a quadrivalent metal phosphate (e.g., a phosphate of a quadrivalent metal such as the metals of the Group 4A and 4B elements of the Periodic Table) and a bivalent metal hydroxide (e.g., a hydroxide of a bivalent metal such as the metals of the Group 2A, 6A, 7A, 8, 1B and 2B elements of the Periodic Table). In addition, it is preferred that the dust-collecting agent contains water of crystallization or moisture corresponding thereto under a general environment and also is capable of collecting an acidic gas and/or a basic gas through a chemical bond. For example, at least one member selected from the group consisting of the quadrivalent metal phosphate and the bivalent metal hydroxide (in particular both quadrivalent metal phosphate and the bivalent metal hydroxide) may be a hydrate or may be in a hydrate form. The photocatalyst preferably comprises an optical semiconductor, more preferably an oxide semiconductor, and most preferably an oxide of a metal such as the metals of the Group 4A, 6A, 2B and 4B elements of the Periodic Table (for example, titanium dioxide). In the dustproof fiber, the content of the photocatalyst is preferably about 0.1 to 25 parts by weight relative to 100 parts by weight of the dustproof fiber, and the content of the dust-collecting agent is preferably about 1 to 25 parts by weight relative to 100 parts by weight of the dustproof fiber. Incidentally, a fiber before preparing a fabric (or cloth) may contain the photocatalyst, or a prepared fabric (or cloth) may directly contain the photocatalyst. The dustproof fiber may comprise, for example, a polyester-series fiber. The dustproof fiber may have a twist number of about 0 to 200 T/m (twist/meter), and may be a multifilament fiber having ayarn fineness of about 56 to 220 dtex (decitex). Moreover, the fabric may further comprise a conductive fiber. The fabric can satisfy the following required characteristics (1) and (2):

(1) the collection efficiency is not less than 70%, and

(2) the air permeability is 8 to 100 cm/second.

Such a dustproof clothing is particularly suitable for clothes used in a clean room.

Examples of a method for allowing a fiber to contain the photocatalyst and the dust-collecting agent include a method which comprises supporting (or carrying) the photocatalyst and the dust-collecting agent on a surface of a fiber, and a method which comprises fiber-forming a resin composition comprising the photocatalyst, the dust-collecting agent and a fiber-formable resin to contain (or hold) the photocatalyst and the dust-collecting agent in the formed fiber. In the present invention, the photocatalyst and the dust-collecting agent may be in the form of a mixture. For example, these components premixed in a state of powder may be used, or these components may be mixed in a liquid dispersion or a polymer.

The present invention also includes a use of a clothing for collecting dust, wherein the clothing comprises a fabric, and at least part of the fabric comprises a dustproof fiber containing a photocatalyst and a dust-collecting agent. The present invention further includes a use of the above fabric, or the above fiber.

Further, the present invention includes a method for collecting dust, which comprises bringing dust into contact with a dustproof clothing, wherein the dust clothing comprises a fabric, and at least part of the fabric comprises a dustproof fiber containing a photocatalyst and a dust-collecting agent. The present invention also includes a method for collecting dust, which comprises bringing dust into contact with the above fabric, or the above fiber.

Throughout this specification, unless otherwise indicated, the term “contain(s)” is used as the term which means not only inclusion morphology of the photocatalyst and the dust-collecting agent by fiber-forming (or spinning) but also adhering (or attaching) morphology of the photocatalyst and the dust-collecting agent. Moreover, the number of group in the Periodic Table is described based on IUPAC Commission on Nomenclature of Inorganic Chemistry, Definitive Rules 1970.

The term “yarn” is used in weaving and knitting to form a fabric (or cloth), and may comprise a filament (or thread) such as a monofilament and a multifilament, or a staple fiber. The term “fiber” includes a filament fiber (i.e., continuous fiber) and a staple fiber (i.e., cut fiber).

### DETAILED DESCRIPTION OF THE INVENTION

The dustproof (or anti-dust) clothing of the present invention comprises at least a dustproof fiber containing a photocatalyst and a dust-collecting agent. That is, the dustproof clothing comprises a fabric, and at least part of the fabric comprises a dustproof fiber containing a photocatalyst and a dust-collecting agent.

[Dustproof Fiber]

A fiber as the dustproof fiber is not particularly limited to a specific one, and may be any one of a synthetic fiber, a semisynthetic fiber, a regenerated fiber, and a natural fiber.

The synthetic fiber includes various fibers obtainable from a fiber-formable resin, for example, a polyester-series fiber (e.g., an aromatic polyester fiber such as a polyethylene terephthalate fiber, a polytrimethylene terephthalate fiber, a polybutylene terephthalate fiber, and a polyethylene naphthalate fiber), a polyamide-series fiber (e.g., an aliphatic polyamide-series fiber such as a nylon 6, a nylon 66, a nylon 11, a nylon 12, a nylon 610, and a nylon 612; an alicyclic polyamide-series fiber; an aromatic polyamide-series fiber such as a polyphenylene isophthalamide, a polyhexamethylene terephthalamide, and a poly-p-phenylene terephthalamide), a polyolefinic fiber (e.g., a polyethylene fiber, and a polypropylene fiber), an ethylene-vinyl alcohol-series copolymer fiber, a polyvinyl chloride-series fiber (e.g., a fiber such as a polyvinyl chloride, a vinyl chloride-vinyl acetate copolymer, and a vinyl chloride-acrylonitrile copolymer), a polyvinylidene chloride-series fiber (e.g., a fiber of a vinylidene chloride-vinyl chloride copolymer, or a vinylidene chloride-vinyl acetate copolymer), a polyurethane fiber, an acrylic fiber (e.g., an acrylonitrile-series fiber having an acrylonitrile unit, such as an acrylonitrile-vinyl chloride copolymer), a polyvinyl alcohol-series fiber such as a vinylon, a polychlal fiber, a fluorine-containing fiber, a protein-acrylonitrile copolymer-series fiber, a polyglycolic acid fiber, and a phenol resin fiber.

Examples of the semisynthetic fiber include an acetate fiber such as a triacetate fiber. The regenerated fiber includes, for example, a rayon, a polynosic, a cupra, a lyocell [e.g., TENCEL (registered trademark)], and others. Incidentally, the semisynthetic fiber and the regenerated fiber may be a fiber obtainable from a fiber-formable resin. As the natural fiber, there may be mentioned, for example, a cotton, a sheep wool, a silk, a hemp, and others. Further, depending on application, an inorganic fiber such as a glass fiber, a carbon fiber, and a metal fiber may be used.

These fibers may be used singly or in combination. In view of inhibition of the above-mentioned clothing dust, the preferred fiber among these fibers includes the synthetic fiber such as a polyamide-series fiber, a polyester-series fiber, an acrylic fiber, and a polyurethane-series fiber; the semisynthetic fiber such as an acetate fiber; and the regenerated fiber such as a rayon, a polynosic, and a cupra.

In particular, a polyC₂₋₄alkylene arylate-series fiber such as a polyethylene terephthalate fiber, a polybutylene terephthalate fiber, and a polyethylene naphthalate fiber is preferred. Incidentally, the polyC₂₋₄alkylene arylate-series fiber includes a fiber composed of a polyC₂₋₄alkylene arylate homopolymer, and a fiber composed of a modified polyC₂₋₄alkylene arylate. Examples of the modified polyC₂₋₄alkylene arylate include a modified polyC₂₋₄alkylene arylate obtained by copolymerizing a dicarboxylic acid unit such as isophthalic acid (or a C₁₋₄alkyl ester thereof) in a proportion of about 0.1 to 50 mol %, preferably about 0.3 to 30 mol %, and more preferably about 0.5 to 10 mol % relative to the total dicarboxylic acid unit, in addition to terephthalic acid and/or 2,6-naphthalenedicarboxylic acid as a dicarboxylic acid unit.

These fibers may preferably be in the form of a continuous fiber (a so-called filament fiber). In view of durability and fibrillation of the fiber, the more preferred fiber includes a continuous fiber (or multifilament fiber) of the synthetic fiber. That is, as a base yarn or filament of a fabric for a dustproof clothing, the continuous fiber of the synthetic fiber having no free end, particularly a textured or processed yarn composed of a polyester continuous fiber, is preferably used in terms of hardly generating dust from a clothing.

The photocatalyst to be used in the present invention is the catalyst that generates an active oxygen by irradiating with rays such as ultraviolet rays and visible rays, and has a function making the dust-collecting agent hydrophilic (particularly a function inducing super-hydrophilic phenomenon). The photocatalyst includes various optical semiconductors irrespective of organic or inorganic one, and in practical cases an inorganic semiconductor (e.g., a sulfide semiconductor, a metal chalcogenide, and an oxide semiconductor) is used. The photocatalyst preferably includes a sulfide semiconductor such as a sulfide of the metal of the Group 2B elements of the Periodic Table (e.g., CdS and ZnS), and an oxide semiconductor such as an oxide of the metal of the Group 4A elements of the Periodic Table (e.g., TiO₂), an oxide of the metal of the Group 6A elements of the Periodic Table (e.g., WO₃), an oxide of the metal of the Group 2B elements of the Periodic Table (e.g., ZnO), and an oxide of the metal of the Group 4B elements of the Periodic Table (e.g., SnO₂). Further preferred photocatalyst includes an oxide semiconductor such as an oxide of the metal of the Group 4A elements of the Periodic Table, and an oxide of the metal of the Group 2B elements of the Periodic Table (particular a titanium oxide such as TiO₂). The crystal structure of the optical semiconductor constituting the photocatalyst is not particularly limited to a specific one. For example, TiO₂ may be in any form such as an anatase form, a brookite form, a rutile form, and an amorphous form.

The content of the photocatalyst may be selected, depending on the structure of the fiber, from a range without adversely affecting the catalytic activity. The content of the photocatalyst relative to 100 parts by weight of the dustproof fiber is about 0.1 to 25 parts by weight, preferably about 0.3 to 15 parts by weight, and more preferably about 0.5 to 10 parts by weight. In the case where the content of the photocatalyst is too small, the catalytic activity is insufficient. On the other hand, too large content of the photocatalyst induces a fall of the photocatalyst from the dustproof clothing, and causes many problems such as thread breakage in the fiber production or fabrication and the abrasion of the guide (or the thread), so that such contents are therefore unsuitable for the industrial production. Incidentally, also in the case containing the photocatalyst in a prepared fabric, the photocatalyst may be used in the above proportion relative to the whole fabric.

The photocatalyst may be used in the form of a sol, a gel, or a particulate, independently from a dust-collecting agent. The photocatalyst is preferably used as a composition or composite (or complex) in combination with a dust-collecting agent (e.g., a quadrivalent metal phosphate, and a bivalent metal hydroxide). The use of the composition or composite (or complex) comprising the photocatalyst and the dust-collecting agent ensures a high catalytic activity, and improves a dust collection efficiency of the dust-collecting agent. Accordingly, the anti-dust effect sustains for a long period of time.

Incidentally, in the case using the particulate photocatalyst, the mean particle size of the photocatalyst is, for example, about 0.01 to 25 μm, preferably about 0.05 to 10 μm, and more preferably about 0.05 to 5 μm.

Concrete examples of the dust-collecting agent to be used together with the photocatalyst preferably include a mixture of a quadrivalent metal phosphate and a bivalent metal hydroxide. The quadrivalent metal in the phosphate is not particularly limited to a specific group in the Periodic Table as far as the metal is a quadrivalent one. The quadrivalent metal includes the metal of the Group 4 elements of the Periodic Table, for example, the metal of the Group 4A and 4B elements. Among these metals, the metal of the Group 4A elements of the Periodic Table (e.g., titanium, zirconium, and hafnium), and the metal of the Group 4B elements of the Periodic Table (e.g., tin, germanium, and lead) are preferred.

Examples of the phosphoric acid in the phosphate include various phosphoric acids, e.g., orthophosphoric acid, metaphosphoric acid, pyrophosphoric acid, triphosphoric acid, and tetraphosphoric acid. Among these phosphoric acids, orthophosphoric acid is preferred. Thereinafter, unless otherwise indicated, the term “phosphoric acid” means orthophosphoric acid.

The quadrivalent metal phosphate is usually insoluble or sparingly soluble in water. Further, the phosphate may be a crystalline salt, and is preferably a noncrystalline salt. These quadrivalent metal phosphates may be used singly or in combination. Furthermore, the phosphate tends to be a hydrated state (e.g., a hydrated phosphate), and thus is effective as a water-containing dust-collecting agent. That is, the phosphate preferably contains water of crystallization or moisture corresponding thereto in a hydrate form or water-containing form.

As the bivalent metal forming the hydroxide, it is sufficient to be a bivalent metal irrespective of the number of group in the Periodic Table. The bivalent metal includes, for example, the metal of the Group 2A elements (e.g., magnesium), 6A elements (e.g., chromium), 7A elements (e.g., manganese), 8 elements (e.g., iron, and nickel), 1B elements (e.g., copper) and 2B elements (e.g., zinc, and cadmium) of the Periodic Table. These bivalent metal hydroxides may be used singly or in combination. The preferred bivalent metal includes, a transitional metal, for example, copper, zinc, iron, and nickel.

The bivalent metal hydroxide is usually insoluble or sparingly soluble in water between weak acidic range and weak alkaline range (from pH 4 to 10). Moreover, the hydroxide may be crystalline, and is noncrystalline in practical cases. Further, the bivalent metal hydroxide tends to be a hydrated state (e.g., a hydrated bivalent metal hydroxide), and thus is effective as a water-containing dust-collecting agent. That is, the bivalent metal hydroxide preferably contains water of crystallization or moisture corresponding thereto in a hydrate form or water-containing form.

The proportion of the quadrivalent metal phosphate relative to the bivalent metal hydroxide may be selected from any range as far as the catalytic activity and the dust collection efficiency are not deteriorated. For example, the weight ratio of the metal atom [bivalent metal/quadrivalent metal] is about 0.1 to 10, preferably about 0.2 to 7, and more preferably about 0.2 to 5. Incidentally, in the case using a plurality of phosphates and/or hydroxides in combination, it is sufficient that the weight ratio of the metal atom on the basis of the total amount of each metals is in the above-mentioned range. Moreover, in the composition comprising the quadrivalent metal phosphate and the bivalent metal hydroxide, the phosphate and the hydroxide may be independent of each other, or may be a compounded or complexed one by a co-precipitation, such as a mixed gel. Incidentally, the composition or composite comprising the phosphate and the hydroxide, and the composition or composite comprising the phosphate, the hydroxide and the photocatalyst may for example be produced in accordance with a manner described in Japanese Patent Application Laid-Open No. 284011/1996 (JP-8-284011A) or other means.

The content of the dust-collecting agent may be also selected depending on the fiber structure or other factors, and, for example, is about 1 to 25 parts by weight, preferably about 1 to 15 parts by weight, and more preferably about 1 to 10 parts by weight, relative to 100 parts by weight of the dustproof fiber. In the case where the content of the dust-collecting agent is too small, the collection property deteriorates. On the other hand, when the content of the dust-collecting agent is too large, the dust-collecting agent is liable to fall from the dustproof clothing. Incidentally, also in the case containing the dust-collecting agent in a prepared fabric, the dust-collecting agent may be used in the above-mentioned proportion relative to the whole fabric.

The amount of the photocatalyst is, for example, about 1 to 1000 parts by weight, preferably about 10 to 750 parts by weight, and more preferably about 20 to 500 parts by weight (particularly about 30 to 100 parts by weight), relative to 100 parts by weight of the dust-collecting agent (total amount of the quadrivalent metal phosphate and the bivalent metal hydroxide).

The dustproof fiber may comprise various additives used for fiber, such as a stabilizer (e.g., an antioxidant, an ultraviolet ray absorbing agent, and a heat stabilizer), a flame retardant, a antistatic agent, a coloring agent, a lubricant, an antibacterial agent, an insecticide or acaricide, a fungicide, a delustrant, a thermal storage medium, a perfume material, a fluorescent brightener, a wetting agent, a plasticizer, a thickener, a dispersing agent, and others.

The high dust collection efficiency can be realized by the present invention presumably due to a slight amount of water or moisture in the above-mentioned dust-collecting agent, and further due to the combination use of the dust-collecting agent and the photocatalyst. Dust is usually in the form of a particle. The particle size of dust is not particularly limited to a specific one, and is for example not more than several micrometers. In a dust fine particle having a particle size of not more than several micrometers, generally, a liquid bridging force is dominant for the adherence of the fine particles. Thus, a dust fine particle can be effectively collected by the dustproof fiber (the dustproof fabric or clothing) due to the liquid bridging force when water is interposed between the dust-collecting agent (e.g., the quadrivalent metal phosphate and the bivalent metal hydroxide) containing a slight amount of water and the dust fine particle. According to the present invention, since a slight amount of water of the dust-collecting agent is spread all over the surface of the dust-collecting agent by a super-hydrophilization due to photocatalyst function, the dust fine particle becomes easily collected on the surface of the dust-collecting agent. Thus, it is considered that a high dust collection efficiency is expressed. The amount of water contained in the dust-collecting agent is, for example, about 0.1 to 20% by weight, preferably about 0.5 to 15% by weight, and more preferably about 0.8 to 10% by weight, relative to the total amount of the dust-collecting agent.

Thus, the dustproof fiber, the dustproof fabric (or cloth) or the dustproof clothing of the present invention have a high dust collection efficiency because of containing the photocatalyst and the dust-collecting agent in combination.

The method for producing the dustproof fiber includes a method of adhering (or bonding) the photocatalyst and the dust-collecting agent to a fiber surface with the use of a binder (or binding agent), and a method of spinning (or fiber-forming) a resin composition comprising the photocatalyst, the dust-collecting agent, and the fiber-formable resin. Further, in the method using the binder, the photocatalyst and the dust-collecting agent may be adhered to a fiber, or may be adhered to a prepared (or produced) fabric or cloth.

The method using the binder is not particularly limited to a specific manner, and for example includes a conventional manner such as a method of adhering (or bonding) the photocatalyst and the dust-collecting agent to the fiber or fabric with the use of the binder such as an adhesive resin with preventing a fall of the photocatalyst and the dust-collecting agent from the surface of the fiber or fabric, a method of adhering the photocatalyst and the dust-collecting agent to a binder-coated surface of the fiber or fabric, a method of impregnating the fiber or fabric with a liquid dispersion containing the photocatalyst and the dust-collecting agent, and optionally a binder, and a method of spraying or coating the liquid dispersion on the fiber or fabric.

The binder is not particularly limited to a specific one as far as the binder is a known binding resin. For example, as the binder, there may be used a thermoplastic resin such as a polyolefinic resin (e.g., a solvent-soluble polyolefin), a vinyl-series polymer (e.g., a polyvinyl acetate, an ethylene-vinyl acetate copolymer, and a polyvinyl chloride), an acrylic resin, a styrenic resin, a polyester-series resin, a polyamide-series resin, and a polyurethane-series resin; and a thermosetting resin such as a silicone resin. These binders may be used singly or in combination. Moreover, these binders may be used in the form of a solution or a liquid dispersion, or further may be used in a molten state.

In the method of fiber-forming (or spinning) a resin composition comprising the photocatalyst, the dust-collecting agent, and the fiber-formable resin, the photocatalyst and the dust-collecting agent may be contained uniformly throughout the fiber, and may be contained in the fiber with concentration gradient in the radius direction of the fiber. In particular, from the viewpoint of the dust collection efficiency, it is preferred that the photocatalyst and the dust-collecting agent are contained or distributed at least on the fiber surface (or fabric surface). Therefore, the fiber may be a composite fiber having a composite structure which is composed of a layer containing a higher concentration of the photocatalyst and the dust-collecting agent and a layer containing a lower concentration thereof. For example, the fiber may be a sheath-core structure conjugated fiber which has a layer (or sheath) containing a higher concentration (e.g., about 0.1 to 50% by weight, preferably 0.5 to 30% by weight, and more preferably about 1 to 20% by weight) of the photocatalyst and the dust-collecting agent in the fiber surface (a so-called sheath), and a layer (or core) containing a lower concentration (e.g., about 0 to 10% by weight, preferably about 0 to 5% by weight, and more preferably about 0 to 1% by weight) of or free from these components in the core. Such a composite fiber having a sheath-core structure can retain of the fiber strength, and can express a high dust collection efficiency.

The cross-sectional structure of the dustproof fiber is not particularly limited to a specific one, and may for example be a round cross-section, in addition a modified (or irregular) cross-section [e.g., a hollow form, a flat (or shallow) form, an elliptical form, a polygonal form, a multi-leaves form from tri-leaves to 14-leaves, a T-shaped form, a H-shaped form, a V-shaped form, and a dog bone form (I-shaped form)]. In order to enhance the dust collection efficiency, it is advantageous to use a fiber which has a modified cross-section showing a large specific surface area. Further, a fiber having the composite structure and the modified structure in combination may be used. The fiber fineness of the single filament (or fiber) is, for example, about 0.5 to 5 dtex (decitex), and preferably about 1 to 4 dtex, from the viewpoint of dustproof effects and comfortableness. Moreover, in the use of the continuous fiber, to realize a fabric having such a thickness that is suitable for a dustproof clothing, the yarn fineness of the multifilament is, for example, about 56 to 220 dtex, preferably about 70 to 200 dtex, and more preferably about 100 to 180 dtex.

[Fabric or Dustproof Fabric]

In the fabric (or dustproof fabric or cloth) of the present invention, at least part of the fabric (or the dustproof fabric) comprises the dustproof fiber. That is, the fabric of the present invention may be prepared with the dustproof fiber. In such a fabric, the dustproof fiber maybe used in all or part of fibers constituting the fabric. The fabric obtained by using the dustproof fiber in part of fibers constituting the fabric includes, for example, a fabric prepared with a sheath-core structure textured yarn which comprises a regular filament (a filament made from a fiber free from both the photocatalyst and the dust-collecting agent) as a core component, and the dustproof fiber as a sheath component; a fabric obtained from a regular filament (or yarn) as a warp, and a filament (or yarn) made from the dustproof fiber as a weft; and a fabric prepared with a combined filament yarn or twisted union yarn of a regular filament and the dustproof fiber filament.

The structure of the fabric may be any one of a knit fabric (or knitting), a woven fabric (or weaving), and a nonwoven fabric, or may be a combination thereof. It is sufficient that the proportion of the dustproof fiber in the fabric is not less than 10% by weight (e.g., about 10 to 100% by weight). The proportion is preferably not less than 20% by weight (e.g., about 20 to 100% by weight), and more preferably not less than 50% by weight (e.g., about 50 to 100% by weight). Although it is not necessary that the fabric is wholly made from the dustproof fiber, an increase of the proportion of the dustproof fiber provides the significant effects of the present invention.

Further, in order to achieve low air permeability, both the warp density and the weft density of the fabric are preferably denser than those of a fabric used for a common clothing. From the viewpoint of higher weight, a twill weave or plane weave is preferred.

The textured or finished yarn, as a raw material may be a twisted yarn. In view of reducing spaces between yarns of a fabric weave, it is preferred to use a non-twisted yarn or a soft (or slightly) twisted yarn (for example, a yarn whose twist number is about 0 to 200 T/m, preferably about 0 to 180 T/m, and more preferably about 0 to 150 T/m). The air permeability of the fabric may be freely regulated depending on a yarn fineness of a textured yarn as a raw material to be used, a filament configuration, a warp density, a weft density and a woven fabric weave, further crease-flex effects in a dyeing and finishing process, and a condition of a width and roll length of the fabric, or others. Moreover, the air permeability may be controlled by once producing a fabric having a high air permeability, and then decreasing the air permeability to a predetermined level by coating with resin or others. The weight (fabric weight) of the fabric per unit area, in the case of a woven fabric, is, for example, about 50 to 300 g/m², preferably about 70 to 250 g/m², and more preferably about 100 to 200 g/m², from the viewpoint of the air permeability and the dustproof function. In the fabric having such a weight, for example, when the warp and the weft are 50 to 120 dtex (particularly 70 to 100 dtex) and 125 to 200 dtex (particularly 140 to 180 dtex), respectively, the warp density and the weft density are preferably about 142 to 182 lines/inch and about 85 to 105 lines/inch, respectively.

Moreover, if necessary, to give an antistatic property, an electrically conductive property may be imparted to the fiber or fabric. As a method for imparting the electrically conductive property, there may be mentioned imparting an antistatic property to the fabric by post-treatment (e.g., by coating the fabric with a conductive component). In order to inhibit clothing dust, e.g., falling of the conductive component, a method of using a conductive yarn is preferred. The conductive yarn usually includes a yarn comprising a durable conductive fiber, e.g., a yarn which comprises a sheath-core structure conjugated fiber comprising a conductive polymer, as a core component, in which a conductive agent (such as a conductive carbon black, a graphite powder, a metal powder and a carbon powder) is kneaded, and a polymer having an excellent strength retentivity as a sheath component. The content of the conductive agent in the conductive fiber is, for example, about 0.1 to 20 parts by weight, preferably about 0.5 to 10 parts by weight, and more preferably about 1 to 5 parts by weight, relative to 100 parts by weight of the conductive fiber. Further, in the case of the sheath-core structure conjugated fiber comprising the conductive agent-containing polymer as a core component, the proportion of the conductive agent in the core component is, for example, about 15 to 60% by weight, and preferably about 20 to 55% by weight. Furthermore, in view of preventing breakage of the fiber, the conductive fiber is preferably woven or knitted as a yarn of 3 to 20 multifilaments into the fabric at regular or constant intervals. The conductive fiber may be preferably introduced into the fabric in a proportion of 1 strand per inch or thicker pitch, e.g., about 20 to 1 strands per inch, preferably about 10 to 1.2 strands per inch, and more preferably about 5 to 1.5 strands per inch, regarding the conductive multifilament comprising a plurality of filaments as one strand (or one yarn), in accordance with objective antistatic degrees.

Incidentally, the fiber to be used in the present invention may be treated by any process or proofing such as a false-twist texturing process, an interlace process, a taslan process, a crimp process, a mercerization process, a shrink proofing, a crease proofing, a hydrophilic process, a water proofing, and a dye proofing, depending on the purpose or the species of fiber.

[Dustproof Clothing]

The dustproof clothing of the present invention comprises the above-mentioned fabric (dustproof fabric). Moreover, the thickness of the fabric used for the dustproof clothing is not particularly limited to a specific one as far as the fabric can be used for a dustproof clothing without deteriorating the objective effects of the invention. Further, in the clothing, the fabric may be layered with another fabric or sheet as far as the effects of the invention are not deteriorated. In the case where the fabric is a woven fabric, the thickness of the fabric is usually, for example, about 0.12 to 0.5 mm, preferably about 0.15 to 0.4 mm, and more preferably about 0.2 to 0.3 mm, at room temperature (about 15 to 25° C.) under a pressure of 23.5 kPa.

Incidentally, it is not necessary that all parts of the dustproof clothing are composed of the same fabric. In part (or area) of the clothing, which generates dust easily and requires a higher air permeability, the part of the clothing may comprise the dustproof fabric. The other part (or rest) of the clothing may comprise a fabric used for a conventional dustproof clothing. Moreover, in part (or area) of the clothing, which generates dust easily and requires a higher air permeability, the part of the clothing may comprise a dustproof fabric comprising a large amount of the dustproof fiber. The other part (or rest) of the clothing may comprise a dustproof fabric comprising a small amount of the dustproof fiber in the other part.

In the dustproof clothing of the present invention, the air permeability of the fabric is, for example, about 8 to 100 cm/second, preferably about 9 to 80 cm/second, and more preferably about 10 to 50 cm/second. In the case where the air permeability is too low, since a wearer feels too muggy on wearing the dustproof clothing so that a wearing comfortableness as the object of the present invention is hardly realized. Moreover, an excessive air permeability confronts difficulty for imparting a higher dust collection efficiency to the fabric concurrently. The air permeability is measured in accordance with JIS (Japanese Industrial Standards) L-1096.27.A (Frazier method). The air permeability may be freely varied by a fiber fineness of a fiber constituting the fabric, a yarn fineness of a yarn, a weave density of the fabric, a weight of the fabric per unit area, and other factors.

In the dustproof clothing of the present invention, the higher dust collection efficiency of the fabric is attributed to higher degree of inhibition of dust generation. The fabric therefore has preferably higher dust collection efficiency, for example a dust collection efficiency of not less than 70% (e.g., about 70 to 100%), preferably not less than 75% (e.g., about 75 to 99%), and more preferably not less than 80% (e.g., about 80 to 95%). In the case where the dust collection efficiency is too low, the fabric is inadequate to use for a dustproof clothing. In particular, the fabric having a dust collection efficiency of not less than 80% effectively inhibits dust generation, therefore, such a fabric can be used in the application required for a higher dust collection efficiency (e.g., application in a clean room). The dust collection efficiency is measured by the following manner. A sample fabric is allowed to cover an opening of a circular cone with a diameter of 25 cm and a height of 25 cm. Air is allowed to pass through the fabric at a suction of 2.83 liter/minute, and a concentration (A) of dust (the particle size of not more than 0.3 μm) in the air is determined by a particle counter. Immediately after the measurement, a concentration (B) of dust in the air is measured in the same manner as the concentration (A) except that the sample fabric is removed from the circular cone. By using the concentrations, (A) and (B), the dust collection efficiency is calculated based on the following formula:

Dust collection efficiency (%)=(1−A/B)×100

Incidentally, just before the measurement of (A), a dust concentration (B₀) may be measured in the same manner as in the dust concentration measurement (B). In the case where the concentration (B₀) significantly differs from the concentration (B), it is preferred to remeasure the concentration (B) for enhancing the accuracy of measurement.

According to the present invention, since the dustproof clothing comprises a fabric as well as at least part of the fabric comprises the dustproof fiber containing the photocatalyst and the dust-collecting agent, the dustproof clothing has compatibility of a high dust collection efficiency and an air permeability. That is, the dustproof clothing has a high dust collection efficiency and an air permeability with an enhanced or improved level, and ensures comfortableness to wear without feeling muggy. The dustproof clothing of the present invention is therefore suitable for a work clothing (or working wear) in a clean room, and others.

In order to inhibit the dust generation from the viewpoint of allergosis prevention, for example, the dustproof clothing of the present invention may be used as a clothing or garment for daily or hospital use (e.g., a clothing or garment such as a lingerie, an inner fabric, a sweater or jumper, a jacket, a pajama, a gown, a white coat or lab coat, slacks (e.g., trousers, or pants), a sock, a glove, a stocking, an apron, and a hat or cap; a mask; a towel or wiper; and a handkerchief). Further, the dustproof clothing of the present invention is suitable for an application required a high dust collection efficiency and an air permeability, for example, is suitably used as a clothing or garment (e.g., a clothing such as a work clothing, a hat or cap, and a grove; a mask; and a towel or wiper) for a clean room in various electronics fields such as a semiconductor technology. For example, the work clothing for a clean room (clean room clothing) includes, depending on a cleanliness level of the clean room, a high-performance air-intake type coverall combined with a hood having a lifesaver, a common two-piece suit with a hood, a general-purpose two-piece suit, and others. The dustproof clothing of the present invention is adaptable for all these applications.

### EXAMPLES

The following examples are intended to describe this invention in further detail and should by no means be interpreted as defining the scope of the invention.

### Example 1

[Preparation of Zn(OH)₂-Ti₃(PO₄)₄-TiO₂ composition]

To one liter of a distilled water was added an aqueous solution (60 g) of titanium sulfate (concentration of 30% by weight), and the resulting solution was mixed. To the mixture was added dropwise an aqueous solution (about 98 g) of phosphoric acid (concentration of 15% by weight) with mixing to give a white precipitate. Further, 50.3 g of zinc sulfate (ZnSO₄0.7H₂O) was added dropwise to the resultant mixture under stirring. To the resulting opaque aqueous solution was added dropwise an aqueous solution of sodium hydroxide (concentration of 15% by weight) with mixing to adjust the pH value to 7.0, and a mixture of a white precipitate containing Zn(II)-Ti(IV) was obtained. To the resultant containing the mixture of the precipitate, titanium tetrachloride (37 g) was added dropwise under stirring, and further an aqueous solution of sodium hydroxide (concentration of 15% by weight) was added dropwise with mixing to adjust the pH value to 7.0, and a precipitate containing titanium oxide was obtained. The obtained precipitate was filtered, washed with a warm deionized water thoroughly, dried, and pulverized to a particulate having a mean particle size of not more than 120 μm, then a composition containing Zn(OH)₂, Ti₃(PO₄)₄ and TiO₂ at a weight ratio [Zn(OH)₂/Ti₃(PO₄)₄/TiO₂] of 38/28/34 was obtained.

[Production of Fiber]

The composition obtained by the above manner was added to a DMIS-modified polybutylene terephthalate (PBT) [a copolymer modified with 2.5 mol % of dimethyl isophthalate (DMIS) relative to the total dicarboxylic acid component] in a proportion of 5% by weight relative to the total weight, and the mixture was extruded with kneading by a conventional method to prepare a pellet. The PBT pellet and a pellet composed of a regular PET (polyethylene terephthalate) for fiber were subjected to fiber-forming by a sheath-core structure conjugated melt spinning method at a sheath/core ratio of 50/50 (weight ratio) with disposing the PBT pellet and the PET pellet as a sheath component and a core component, respectively. Further the obtained fiber was subjected to stretching and false-twisting processes to give a textured yarn having a round cross-section, composed of a sheath-core structure composite continuous fiber filament (multifilament) (167 dtex, 48 filament (F), fiber fineness of monofilament: 3.5 dtex, twist number: 0 T/m).

[Production of Fabric]

The textured yarn composed of a sheath-core structure composite continuous fiber filament which was obtained by the above manner, and a textured yarn composed of a continuous fiber of a regular polyester (110 dtex, 48 filament, fiber fineness of monofilament: 2.3 dtex, twist number: 100 T/m) were used as a weft and a warp, respectively, to make a 2/3 twill weave fabric having a fabric weight of 126 g/m (thickness under a pressure of 23.5 kPa: 0.22 mm). Incidentally, into the fabric, a sheath-core structure conductive filament (multifilament, 44 dtex, 8 filaments) was woven at lcm intervals, where the sheath-core structure conductive filament comprised a nylon 6 as a core component and a nylon 9T as a sheath component. The nylon 6 contained 33% by weight of a conductive carbon, and the nylon 9T was a polyamide obtained from terephthalic acid as a dicarboxylic acid unit and a mixture of 1,9-nonanediamide and 2-methyl-1,8-octanediamine [mixing molar ratio (1,9-nonanediamide/2-methyl-1,8-octanediamine) of 8/2] as a diamine unit. The proportion (weight ratio) of the core relative to the sheath was 13/87. The filament was composed of four domains as the core component in the cross-section of the filament. The dust collection efficiency of the fabric was 84.7%, and the air permeability thereof was 15.5 cm/second.

[Production of Dustproof Clothing]

A two-piece suit with a hood for a clean room was produced by using the above-mentioned fabric in conformity to a standard of a commercially available dustproof clothing of Comparative Example 1, and the test of comfortableness to wear was performed with 10 workers. In a working condition for 8 hours under a room temperature of 25° C. and a humidity of 60% RH (relative humidity), all wearers did not feel heat and humidity at all and felt significantly comfortable to wear even working with perspiration. As a result, the clothing was extremely appreciated.

### Example 2

A 2/3 twill weave fabric having a fabric weight of 133 g/m² (thickness under a pressure of 23.5 kPa: 0.23 mm) was obtained by using the sheath-core structure composite filament produced in Example 1 and a textured yarn composed of continuous fiber of a regular polyester (167 dtex, 48 filament, fiber fineness of monofilament: 3.5 dtex, twist number: 0 T/m) alternately as a weft, and using a textured yarn composed of a continuous fiber of a regular polyester (110 dtex, 48 filament, fiber fineness of monofilament: 2.3 dtex, twist number: 100 T/m) as a warp. Incidentally, into the fabric, the same sheath-core structure conductive filament as in Example 1 was woven at 1 cm intervals. The dust collection efficiency of the fabric was 82.7%, and the air permeability thereof was 9.8 cm/second. Using the fabric, a dustproof clothing was produced in the same manner as in Example 1, and the test of comfortableness to wear was performed with 10 workers similar to Example 1. In a working under the same conditions as Example 1, all wearers did not specially feel heat and humidity and felt comfortable to wear even working with perspiration. As a result, the clothing was appreciated.

### Example 3

A crystal of copper sulfate (43.9 g) was dissolved in one liter of a distilled water, and an aqueous solution (60 g) of titanium sulfate (concentration: 30% by weight) was added to the resulting aqueous solution. About 10 g of 15% by weight phosphoric acid solution was added dropwise to the mixture with stirring under a room temperature to give a white precipitate. The precipitate-containing solution (A solution), and 471 g of a sodium silicate-containing aqueous solution (B solution), which was prepared by diluting sodium silicate with a distilled water to 30% by weight and adding 15% by weight of a sodium hydroxide aqueous solution (30 ml) to the diluted solution, were put in separate beakers with stirring. The A solution and the B solution were added dropwise with stirring in a container charged with 500 ml of a distilled water so that the pH value of the mixture become always about 7. As a result, a bluish white precipitate containing Cu(II)-Ti(IV)-SiO₂ was obtained. The bluish white precipitate was washed thoroughly with a distilled water, and then dried at a room temperature. The dried product was pulverized to give a powder, and the powder was mixed with titanium oxide powder at a proportion of 80 parts by weight of the resulting powder relative to 20 parts by weight of the titanium oxide powder. The resultant mixed powder was further pulverized finely to obtain a mixed powder having a mean particle size of not more than 1 μm containing Cu(II)-Ti(IV)-SiO₂-TiO₂.

In the same manner as in Example 1, the mixed powder was added to the sheath component in the fiber at a proportion of 10% by weight relative to the total weight to produce a sheath-core structure composite continuous fiber filament having a modified cross-section (multifilament) (167 dtex, 48 filament, fiber fineness of monofilament: 3.5 dtex, twist number: 0 T/m). Then, thus obtained fiber was made into a fabric in the same manner as in Example 1, and further into a dustproof clothing. In the fabric, the fabric weight was 128 g/m², the dust collection efficiency was 81.5%, and the air permeability was 13.6 cm/second. The test of comfortableness to wear in the dustproof clothing revealed that the dustproof clothing was somewhat inferior in comfortableness to the clothing of Example 1, but significantly superior to the conventional dustproof clothing.

### Comparative Example 1

A 2/3 twill weave fabric having a fabric weight of 119 g/m (thickness under apressure of 23.5 kPa: 0.18 mm) obtained by using a textured yarn composed of a continuous fiber of a regular polyester (110 dtex, 48 filament, fiber fineness of monofilament: 2.3 dtex, twist number of warp: 100 T/m, twist number of wef t: 0 T/m) commercially available as a fabric for a dustproof clothing, and a two-piece suit with a hood for a clean room were procured. The dust collection efficiency of the fabric was 80.4%, and the air permeability thereof was 4.4 cm/second. The test of comfortableness to wear of the dustproof clothing was performed in the same manner as in Example 1, and 8 out of 10 workers appreciated the clothing as uncomfortable and misery to wear because of muggy heat in a work with perspiration.

### Comparative Example 2

[Preparation of Zn(OH)₂/Ti₃(PO₄)₄ Composition]

An aqueous solution of titanium sulfate (concentration of 30% by weight) was added and mixed to one liter of a distilled water. To the mixture was added dropwise an aqueous solution of phosphoric acid (concentration of 15% by weight) with mixing to give a white precipitate. Further, to the resultant mixture was added dropwise zinc sulfate (ZnSO₄0.7H₂O) under stirring. An aqueous solution of sodium hydroxide (concentration of 15% by weight) was added dropwise to the resulting opaque aqueous solution with mixing to adjust the pH value to 7.0, and a mixture of a white precipitate containing Zn(II)-Ti(IV) was obtained. The obtained precipitate was filtered, washed with a warm deionized water thoroughly, and then dried and pulverized to give a Zn(OH)₂/Ti₃(PO₄)₄ composition.

[Production of Fiber]

The composition (3.5% by weight) obtained by the above manner was added to the above-mentioned DMIS-modified PBT (polybutylene terephthalate), and the mixture was extruded with kneading by a conventional method to prepare a pellet. The pellet and a regular PET (polyethylene terephthalate) for fiber were subjected to fiber-forming by a sheath-core structure conjugated melt spinning method at a weight ratio of 50/50 with disposing the PBT pellet and the PET pellet as a sheath component and a core component, respectively. Further the obtained fiber was subjected to stretching and false-twisting processes to give a textured yarn composed of a sheath-core structure composite filament (167 dtex, 48 filament).

[Production of Fabric]

The textured yarn composed of the sheath-core structure composite filament obtained by the above manner and a textured yarn composed of a regular polyester (110 dtex, 48 filament, twist number: 100 T/m) were used as a weft and a warp, respectively, to make a 2/3 twill weave fabric having a fabric weight of 128 g/m². The dust collection efficiency of the fabric was 84.5%, and the air permeability thereof was 13.8 cm/second.

### Comparative Example 3

Anatase titanium oxide having a photocatalytic activity was added to the above-mentioned DMIS-modified PBT (polybutylene terephthalate) in a proportion of 2.0% by weight relative to the total weight, and the mixture was extruded with kneading by a conventional method to prepare a pellet. The PBT pellet and a regular PET (polyethylene terephthalate) for fiber were subjected to fiber-forming by a sheath-core structure conjugated melt spinning method at a sheath/core ratio of 50/50 (weight ratio) with disposing the PBT pellet and the PET pellet as a sheath component and a core component, respectively. Further, the obtained fiber was subjected to stretching and false-twisting processes to give a textured yarn composed of a sheath-core structure composite filament (167 dtex, 48 filament). The textured yarn composed of the sheath-core structure composite filament obtained by the above manner and a textured yarn composed of a regular polyester (110 dtex, 48 filament) were used as a weft and a warp, respectively, to make a 2/3 twill weave fabric having a fabric weight of 129 g/m². The dust collection efficiency of the fabric was 27%, and the air permeability thereof was 15.4 cm/second.

TABLE 1

| | Ex. 1 | Ex. 2 | Ex. 3 | Com. Ex. 1 | Com. Ex. 2 | Com. Ex. 3 |
|---|---|---|---|---|---|---|
| Weave | 2/3 twill | 2/3 twill | 2/3 twill | 2/3 twill | 2/3 twill | 2/3 twill |
| Warp | regular fiber | regular fiber | regular fiber | regular fiber | regular fiber | regular fiber |
| | 110 dtex/48 F | 110 dtex/48 F | 110 dtex/48 F | 110 dtex/48 F | 110 dtex/48 F | 110 dtex/48 F |
| Weft | sheath-core | regular fiber | sheath-core | regular fiber | sheath-core | sheath-core |
| | structure | 167 dtex/48 F and | structure | 110 dtex/48 F | structure | structure |
| | conjugated | sheath-core | conjugated | | conjugated | conjugated |
| | fiber | structure | fiber | | fiber | fiber |
| | 167 dtex/48 F | conjugated | 167 dtex/48 F | | 167 dtex/48 F | 167 dtex/48 F |
| | | fiber | | | | |
| | | 167 dtex/48 F, | | | | |
| | | alternately | | | | |
| Fabric weight | 126 | 133 | 128 | 119 | 128 | 129 |
| (g/m²) | | | | | | |
| Dust collection | 84.7 | 82.7 | 81.5 | 80.4 | 54.5 | 27 |
| efficiency (%) | | | | | | |
| Air permeability | 15.5 | 9.8 | 13.6 | 4.4 | 13.8 | 15.4 |
| (cm/sec.) | | | | | | |

As shown in Table 1, the fabrics employed in Examples 1 and 2 of the dustproof clothing of the present invention have much higher dust collection efficiency than that of Comparative Example 1 being actually on sale, and ensures a high air permeability at the same time. In the fabric production of the present invention, a textured yarn composed of a sheath-core structure composite filament (167 dtex, 48 filament) containing the photocatalyst and the dust-collecting agent is not necessary needed to be used at a proportion of 100%. Use of the yarn only in the weft as Example 1, or use of the yarn only in the half weft as Example 2 realizes the objects of the present invention. (Moreover, as apparent from Comparative Examples 2 and 3, use of the photocatalyst alone or the dust-collecting agent alone fails to improve the dust collection efficiency as shown in Examples 1 and 2. Therefore, it is revealed that compounding (complex) of the photocatalyst and the dust-collecting agent ensures the improved dust collection efficiency of the present invention).

What is claimed is:

1. A dustproof clothing which comprises a fabric, wherein at least part of the fabric comprises a dustproof fiber containing a photocatalyst and a dust-collecting agent.

2. A dustproof clothing according to claim 1, wherein the dust-collecting agent comprises a quadrivalent metal phosphate and a bivalent metal hydroxide.

3. A dustproof clothing according to claim 1, wherein the dust-collecting agent comprises a phosphate and a hydroxide, and the phosphate comprises at least one quadrivalent metal selected from the group consisting of the metals of the Group 4A and 4B elements of the Periodic Table, and the hydroxide comprises at least one bivalent metal selected from the group consisting of the metals of the Group 2A, 6A, 7A, 8, 1B and 2B elements of the Periodic Table.

4. A dustproof clothing according to claim 2, wherein at least one member selected from the group consisting of the quadrivalent metal phosphate and the bivalent metal hydroxide is in a hydrate form.

5. A dustproof clothing according to claim 2, wherein both the quadrivalent metal phosphate and the bivalent metal hydroxide are in a hydrate form.

6. A dustproof clothing according to claim 1, wherein the photocatalyst comprises an optical semiconductor.

7. A dustproof clothing according to claim 1, wherein the photocatalyst comprises an oxide semiconductor.

8. A dustproof clothing according to claim 1, wherein the photocatalyst comprises an oxide, and the oxide comprises at least one metal selected from the group consisting of the metals of the Group 4A, 6A, 2B and 4B elements of the Periodic Table.

9. A dustproof clothing according to claim 1, wherein the photocatalyst comprises titanium dioxide.

10. A dustproof clothing according to claim 1, wherein the proportion of the photocatalyst is 0.1 to 25 parts by weight relative to 100 parts by weight of the dustproof fiber, and the proportion of the dust-collecting agent is 1 to 25 parts by weight relative to 100 parts by weight of the dustproof fiber.

11. A dustproof clothing according to claim 1, wherein the dustproof fiber comprises a polyester-series fiber.

12. A dustproof clothing according to claim 1, wherein the twist number of the dustproof fiber is 0 to 200 T/m, and the dustproof fiber comprises a multifilament fiber having a yarn fineness of 56 to 220 dtex.

13. A dustproof clothing according to claim 1, wherein the fabric further comprises a conductive fiber.

14. A dustproof clothing according to claim 1, wherein the dust collection efficiency of the fabric is not less than 70%, and the air permeability of the fabric is 8 to 100 cm/second.

15. A dustproof clothing according to claim 1, which is a clothing used in a clean room.

16. A use of a clothing for collecting dust, wherein the clothing comprises a fabric, and at least part of the fabric comprises a dustproof fiber containing a photocatalyst and a dust-collecting agent.

17. A use of a fabric for collecting dust, wherein at least part of the fabric comprises a dustproof fiber containing a photocatalyst and a dust-collecting agent.

18. A use of a fiber for collecting dust, wherein the fiber contains a photocatalyst and a dust-collecting agent.

19. A method for collecting dust, which comprises bringing dust into contact with a dustproof clothing, wherein the dust clothing comprises a fabric, and at least part of the fabric comprises a dustproof fiber containing a photocatalyst and a dust-collecting agent.

20. A method for collecting dust, which comprises bringing dust into contact with a fabric, wherein at least part of the fabric comprises a dustproof fiber containing a photocatalyst and a dust-collecting agent.

21. A method for collecting dust, which comprises bringing dust into contact with a dustproof fiber containing a photocatalyst and a dust-collecting agent.
